(19) United States
(12) Patent Application Publication
(10) Pub. No.: US 2022/0261888 A1
(43) Pub. Date: Aug. 18, 2022

(54) SYSTEM AND METHOD FOR FINANCING AN ELECTRONIC PURCHASE OF A PRODUCT

(71) Applicant: Kumar N Senthil, Sammamish, WA (US)

(72) Inventor: Kumar N Senthil, Sammamish, WA (US)

(21) Appl. No.: 17/178,287

(22) Filed: Feb. 18, 2021

(51) Int. Cl. G06Q 40/02; G06Q 20/40; G06Q 20/10

(52) U.S. Cl. CPC G06Q 40/025; G06Q 20/102; G06Q 20/40

(57) ABSTRACT

A system for financing an electronic purchase of a product is disclosed. A processing subsystem which includes a finance application module to receive a funding request to finance a loan for purchasing one or more products, transmits the funding request to a finance service provider. A credit evaluation module derives finance historical information of the purchaser from one or more external sources, evaluates the finance historical information derived of the purchaser. A finance sanction module to sanction financing of a predefined loan amount, to convert the predefined loan amount upon sanctioning into a virtual credit amount. A transaction completion module determines one or more merchants involved with selling of the corresponding one or more products, identifies a fraction of the virtual credit amount to be transferred to the corresponding one or more merchants, to transmit the fraction of the virtual credit amount to the corresponding one or more merchants.

### BACKGROUND

Embodiments of the present disclosure relate to an online purchasing system and more particularly to a system and a method for financing an electronic purchase of a product.

Online shopping over electronic commerce platform is becoming increasingly popular because of speed and ease of use for customers. The online shopping involves selling of one or more products directly to one or more consumers or other businesses. Business to Consumer (B2C) method of the online shopping involves the online sales of the one or more products, services and provision of information directly to the one or more consumers. Similarly, business to business (B2B) method refers to the online exchange of the one or more products, services, or information between businesses. For selling of the one or more products by either of the methods of online shopping, the electronic commerce websites need to fulfil some of the basic requirements such as shopping cart, secure server and secure payment processing options. Among all, the secure payment processing options is managed either through third party payment processing software, internet merchant accounts issued by one or more financial institutions or through manual credit card processing. Such payment processes are mutually beneficial for both the parties such as the one or more consumers as well as one or more sellers in participating in the online shopping process for purchasing the one or more products.

Conventionally, the payment processes which are applicable in the online shopping includes one or more direct payment options or online financing option in terms of loans. However, such a conventional system involves several conventional loan approval methods which are time-consuming and often involve a considerable amount of wasted effort on the part of the one or more consumers, one or more sellers and lenders alike. Moreover, the one or more consumers initially need to spend a significant amount of time in researching and analyzing for various products, often with the assistance of a seller, before selecting a desired product. Furthermore, the one or more sellers need to research for various loan options which are they can make it available for their customers to purchase one or more desired products which is again an exhaustive process for the sellers. Due to this challenge sometimes, the sellers do not offer financing which prevents customers buying their products. Also, it is frustrating experience for the buyers to submit the loan application individually to each merchant.

Hence, there is a need for an improved system and a method for financing an electronic purchase of a product in order to address the aforementioned issues.

### BRIEF DESCRIPTION

In accordance with an embodiment of the present disclosure, a system for financing an electronic purchase of a product is disclosed. The system includes a processing subsystem hosted on a server. The processing subsystem is configured to execute on a network to control bidirectional communications among a plurality of modules. The processing subsystem includes a finance application module configured to receive a funding request to finance a loan for purchasing one or more products over an electronic commerce platform selected by a purchaser. The finance application module is also configured to transmit the funding request received from the purchaser over a communication network to a finance service provider. The processing subsystem also includes a credit evaluation module operatively coupled to the finance application module. The credit evaluation module is configured to derive finance historical information of the purchaser from one or more external sources based on the funding request received corresponding to purchasing of the one or more products. The credit evaluation module is also configured to evaluate the finance historical information derived of the purchaser for purchasing the one or more products selected based on analysis of a credit report associated with the purchaser. The processing subsystem also includes a finance sanction module operatively coupled to the credit evaluation module. The finance sanction module is configured to sanction financing of a predefined loan amount upon evaluation of the finance historical information. The finance sanction module is also configured to convert the predefined loan amount upon sanctioning into a virtual credit amount for utilization in purchasing of the one or more products selected by the purchaser. The processing subsystem also includes a transaction completion module operatively coupled to the finance sanction module. The transaction completion module is configured to determine one or more merchants involved with selling of one or more corresponding products selected by the purchaser for checkout upon conversion of the predefined loan amount into the virtual credit amount. The transaction completion module is also configured to identify a fraction of the virtual credit amount to be transferred to the corresponding one or more merchants determined based on extraction of a seller information associated with the one or more products from the electronic commerce platform. The transaction completion module is also configured to transmit the fraction of the virtual credit amount to the corresponding one or more merchants for completing transaction of purchasing the one or more products. As a result, the system enables the purchaser to finance the transaction even if the one or more merchants does not offer financing. As the transaction completion module uses virtual credit card, the one or more merchants does not need to make any change to their ecommerce platform to complete the transaction.

In accordance with another embodiment of the present disclosure, a method for financing an electronic purchase of a product is disclosed. The method includes receiving, by a finance application module, a funding request to finance a loan for purchasing one of one or more products over an electronic commerce platform selected by a purchaser. The method also includes transmitting, by the finance application module, the funding request received from the purchaser over a communication network to a finance service provider. The method also includes deriving, by a credit evaluation module, finance historical information of the purchaser from one or more external sources based on the funding request received corresponding to purchasing of the one or more products. The method also includes evaluating, by the credit evaluation module, the finance historical information derived of the purchaser for purchasing the one or more products selected based on analysis of a credit report associated with the purchaser. The method also includes sanctioning, by a finance sanction module, financing of a predefined loan amount upon evaluation of the finance historical information. The method also includes converting, by the finance sanction module, the predefined loan amount upon sanctioning into a virtual credit amount for utilization in purchasing of the one or more products selected by the purchaser. The method also includes determining, by a transaction completion module, one or more merchants involved with selling of one or more corresponding products selected by the purchaser for checkout upon conversion of the predefined loan amount into the virtual credit amount. The method also includes identifying, by the transaction completion module, a fraction of the virtual credit amount to be transferred to the corresponding one or more merchants determined based on extraction of a seller information associated with the one or more products from the electronic commerce platform. The method also includes transmitting, by the transaction completion module, the fraction of the virtual credit amount to the corresponding one or more merchants for completing transaction of purchasing the one or more products.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for financing an electronic purchase of a product in accordance with an embodiment of the present disclosure;

FIG. 2 is a block diagram representation of an embodiment of a system for financing an electronic purchase of a product of FIG. 1 in accordance with an embodiment of the present disclosure;

FIG. 3 illustrates a schematic representation of an exemplary embodiment of a system for financing an electronic purchase of a product of FIG. 1 in accordance with an embodiment of the present disclosure;

FIG. 4 is a block diagram of a computer or a server in accordance with an embodiment of the present disclosure;

FIG. 5(a) illustrates a flowchart representing the steps involved in a method for financing an electronic purchase of a product of FIG. 1 in accordance with an embodiment of the present disclosure; and

FIG. 5(b) illustrates continued steps of the method of FIG. 5(a) in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for financing an electronic purchase of a product. The system includes a processing subsystem hosted on a server. The processing subsystem is configured to execute on a network to control bidirectional communications among a plurality of modules. The processing subsystem includes a finance application module configured to receive a funding request to finance a loan for purchasing of one or more products over an electronic commerce platform selected by a purchaser. The finance application module is also configured to transmit the funding request received from the purchaser over a communication network to a finance service provider. The processing subsystem also includes a credit evaluation module operatively coupled to the finance application module. The credit evaluation module is configured to derive finance historical information of the purchaser from one or more external sources based on the funding request received corresponding to purchasing of the one or more products. The credit evaluation module is also configured to evaluate the finance historical information derived of the purchaser for purchasing the one or more products selected based on analysis of a credit report associated with the purchaser. The processing subsystem also includes a finance sanction module operatively coupled to the credit evaluation module. The finance sanction module is configured to sanction financing of a predefined loan amount upon evaluation of the finance historical information. The finance sanction module is also configured to convert the predefined loan amount upon sanctioning into a virtual credit amount for utilization in purchasing of the one or more products selected by the purchaser. The processing subsystem also includes a transaction completion module operatively coupled to the finance sanction module. The transaction completion module is configured to determine one or more merchants involved with selling of one or more corresponding products selected by the purchaser for checkout upon conversion of the predefined loan amount into the virtual credit amount. The transaction completion module is also configured to identify a fraction of the virtual credit amount to be transferred to the corresponding one or more merchants determined based on extraction of a seller information associated with the one or more products from the electronic commerce platform. The transaction completion module is also configured to transmit the fraction of the virtual credit amount to the corresponding one or more merchants for completing transaction of purchasing the one or more products.

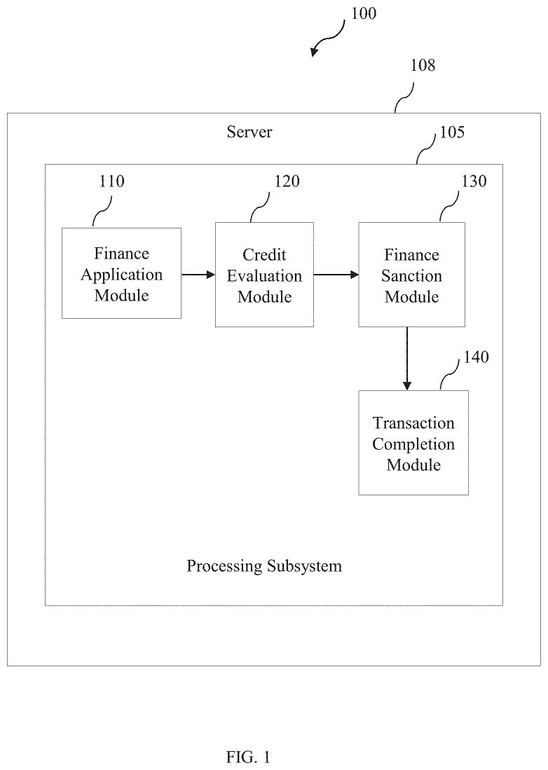

FIG. 1 is a block diagram of a system 100 for financing an electronic purchase of a product in accordance with an embodiment of the present disclosure. The system 100 includes a processing subsystem 105 hosted on a server 108. In one embodiment, the server 108 may include a cloud server. In another embodiment, the server 108 may include a local server. The processing subsystem 105 is configured to execute on a network (not shown in FIG. 1) to control bidirectional communications among a plurality of modules. In one embodiment, the network may include a wired network such as local area network (LAN). In another embodiment, the network may include a wireless network such as Wi-Fi, Bluetooth, Zigbee, near field communication (NFC), infra-red communication (RFID) or the like.

The processing subsystem 105 includes a finance application module 110 configured to receive a funding request to finance a loan for purchasing one or more products over an electronic commerce (e-commerce) platform selected by a purchaser. As used herein, the term ‘electronic commerce platform’ is defined as an online shopping website or a mobile application facilitating purchasing of at least one product by a purchaser via an electronic communication medium. The finance application module 110 is also configured to transmit the funding request received from the purchaser over the communication network to a finance service provider. In one embodiment, the funding request includes at least one of a name of the purchaser, an address proof of the purchaser, a contact detail of the purchaser, an identification details of the purchaser, an income proof details of the purchaser, a type of loan requested by the purchaser, a loan amount requested by the purchaser, a time period of loan or a combination thereof. In such embodiment, the type of the loan includes, but not limited to, a personal loan, a vehicle loan, a gold loan, a home furnishing loan and the like.

The processing subsystem 105 also includes a credit evaluation module 120 operatively coupled to the finance application module 110. The credit evaluation module 120 is configured to derive finance historical information of the purchaser from one or more external sources based on the funding request received corresponding to purchasing of the one or more products. In some embodiment, the finance historical information may include at least one of one or more payment history of the purchaser, a purchase history of the purchaser, a transaction history of the purchaser, a cash flow history of the purchaser, a balance history of the purchaser, a funding source of the purchaser or a combination thereof. In such embodiment, the one or more external sources may include at least one of an external electronic commerce website, a bank, a finance provider, a lender or a combination thereof. As used herein, the term ‘transaction history’ is defined as a record of every transaction of a purchaser within a certain period of time. Similarly, the term ‘cash flow history’ of the purchaser is defined as a financial statement that shows changes in balance sheet accounts and income affect cash and cash equivalents, and breaks the analysis down to operating, investing, and financing activities. Again, the term ‘balance history’ is defined as amount of balance funds or assets available with the purchaser without involving any risk. The term ‘funding source’ is defined as a source from where money originates for carrying out a financial transaction for purchasing the one or more products.

The credit evaluation module 120 is also configured to evaluate the finance historical information derived of the purchaser for purchasing the one or more products selected based on analysis of a credit report associated with the purchaser. The credit report includes a unique credit score associated with the purchaser. As used herein, the term ‘unique credit score’ is defined as a numerical expression based on a level analysis of an individual's credit files to represent the creditworthiness of an individual. The credit report is analyzed for evaluation of the finance historical information by a credit analysis processing engine. In one embodiment, the credit analysis processing engine is configured to fetch a unique credit score associated with the purchaser from an external credit bureau platform using an application programming interface (API). As used herein the term ‘external credit bureau platform’ is defined as a platform associated with a reporting agency that collects and researches individual credit information and sells it for a fee to creditors so they can make decisions on granting loans to a purchaser.

The processing subsystem 105 also includes a finance sanction module 130 operatively coupled to the credit evaluation module 120. The finance sanction module 130 is configured to sanction financing of a predefined loan amount upon evaluation of the finance historical information. The finance sanction module 130 is configured to approve sanction of financing the predefined loan amount when an evaluation score is greater than a predefined threshold limit upon evaluation of the finance historical information. As used herein, the term ‘predefined threshold limit’ is defined as a score set corresponding to an industrial standard for granting of the loan. The finance sanction module 130 is also configured to decline the sanction of financing the predefined loan amount when an evaluation score is lesser than a predefined threshold limit upon evaluation of the finance historical information.

The finance sanction module 130 is also configured to convert the predefined loan amount upon sanctioning into a virtual credit amount for utilization in purchasing of the one or more products selected by the purchaser. In one embodiment, the virtual credit amount is associated with a virtual credit card generated for the purchaser, wherein the virtual credit card is having a set of unique number. As used herein, the term ‘virtual credit card’ is defined as a non-physical card which is created to carry out online transactions. Such virtual credit cards also have a card number, CVV, and validity dates just like a regular credit card.

The processing subsystem 105 also includes a transaction completion module 140 operatively coupled to the finance sanction module 130. The transaction completion module 140 is configured to determine one or more merchants involved with selling of one or more corresponding products selected by the purchaser for checkout upon conversion of the predefined loan amount into the virtual credit amount. In one embodiment, the one or more merchants includes one or more sellers having collaboration with the e-commerce platform for selling their product(s). The transaction completion module 140 is also configured to identify a fraction of the virtual credit amount to be transferred to the corresponding one or more merchants determined based on extraction of a seller information associated with the one or more products from the electronic commerce platform. In some embodiment, the seller information includes, but not limited to, a name of the one or more merchants, a contact details of the one or more merchants, an address of the one or more merchants, a web site link of the one or more merchants, number of quantities of the one or more products sold by the corresponding one or more merchants, a category of the one of the one or more products sold by the one or more merchants and the like. The transaction completion module 140 is also configured to transmit the fraction of the virtual credit amount to the corresponding one or more merchants for completing transaction of purchasing the one or more products.

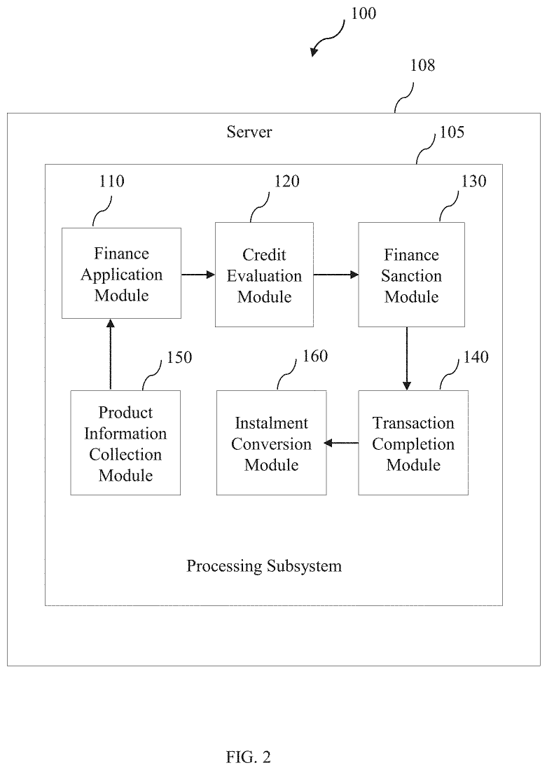

FIG. 2 is a block diagram representation of an embodiment of a system for financing an electronic purchase of a product of FIG. 1 in accordance with an embodiment of the present disclosure. As described in aforementioned FIG. 1, the system 100 includes a processing subsystem 105 which includes a finance application module 110, a credit evaluation module 120, a finance sanction module 130 and a transaction completion module 140. In addition, the processing subsystem further includes a product information collection module 150 configured to collect one or more product details of the one or more products selected by the purchaser for purchasing from the electronic commerce platform. In one embodiment, the one or more product details includes at least one of a name of the one or more products, a quantity of the one or more products, a price of the one or more products, a brand of the one or more products or a combination thereof. In such embodiment, the one or more products may include, but not limited to, an electronic product, a stationary product, an apparel, a home appliance, a fashion accessory, a vehicle, an ornament, a grocery item, a medical instrument and the like.

The processing subsystem also includes an instalment conversion module 160 operatively coupled to the finance sanction module 130. The instalment conversion module 160 is configured to convert the virtual credit amount into a plurality of instalments for purchasing the one or more products based on a predefined requirement of the purchaser. In one embodiment, the plurality of instalments includes a plurality of equated monthly instalments (EMIs). The conversion of the virtual credit amount into the plurality of instalments helps in generation of sales for one or more expensive products which indirectly satisfies the purchaser, the one or more merchants and the one or more finance providers.

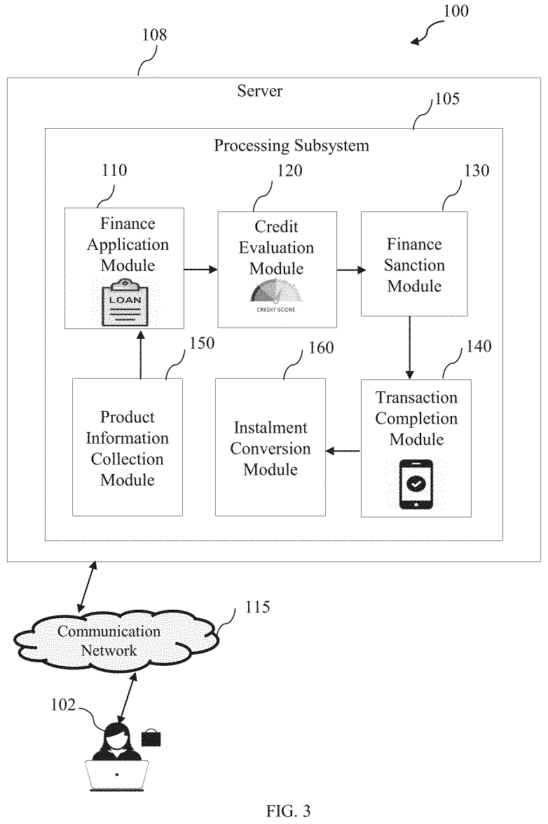

FIG. 3 illustrates a schematic representation of an exemplary embodiment of a system 100 for financing an electronic purchase of a product of FIG. 1 in accordance with an embodiment of the present disclosure. Considering an example, where the system 100 is utilized by an electronic commerce (e-commerce) platform for facilitating payment option during checkout process of an electronic purchase of one or more products. In the example used herein, let's assume that a purchaser ‘X’ 102 has purchased an electronic product from an e-commerce platform ‘Y’. The system 100 enables financing a loan option for purchasing the electronic product ‘X’ to the purchaser. Here, the system 100 provides the financing option without even consideration of availability or unavailability of the financing option with the one or more merchants associated with the e-commerce platform.

For financing of the loan, first the loan application needs to be obtained from the purchaser. A finance application module 110 of a processing subsystem 105 receives a funding request to finance the loan for purchasing the electronic product selected by the purchaser. Here, the product details associated with the product is fetched from a product information collection module 150. The product information collection module 150 collects the one or more product details including at least one of a name of the product, a quantity of the product, a price of the product, a brand of the product or a combination thereof. Also, if the purchaser along with the electronic product also purchases one or more additional products, then the one or more details associated with such one or more products are also collected. Again, the funding request includes at least one of a name of the purchaser, an address proof of the purchaser, a contact detail of the purchaser, an identification details of the purchaser, an income proof details of the purchaser, a type of loan requested by the purchaser, a loan amount requested by the purchaser, a time period of loan or a combination thereof. In such an example, the type of the loan may include a personal loan. Here, the processing subsystem 105 is hosted on a remote server such as a cloud server 108. The processing subsystem 105 is configured to execute on a network to control bidirectional communications among a plurality of modules. For example, the communication network may include a wireless communication network 115.

Upon obtaining the funding request from the purchaser, a credit evaluation module 120 of the processing subsystem 105 derives finance historical information of the purchaser from one or more external sources. In the example used herein, the finance historical information includes at least one of one or more payment history of the purchaser, a purchase history of the purchaser, a transaction history of the purchaser, a cash flow history of the purchaser, a balance history of the purchaser, a funding source of the purchaser or a combination thereof. In such an example, the one or more external sources may include at least one of an external electronic commerce website, a bank, a finance provider, a lender or a combination thereof.

Also, the credit evaluation module 120 evaluates the finance historical information derived of the purchaser for purchasing the at least one product selected based on analysis of a credit report associated with the purchaser. The credit report includes a unique credit score associated with the purchaser. Here, the credit report is analyzed for evaluation of the finance historical information by a credit analysis processing engine. For example, the credit analysis processing engine fetches a unique credit score associated with the purchaser from an external credit bureau platform using an application programming interface (API).

Once, the finance historical information is analyzed, a finance sanction module 130 sanctions financing of a predefined loan amount upon evaluation of the finance historical information. The finance sanction module 130 is also configured to approve sanction of financing the predefined loan amount when an evaluation score is greater than a predefined threshold limit upon evaluation of the finance historical information. Similarly, the finance sanction module 130 is also configured to decline the sanction of financing the predefined loan amount when an evaluation score is lesser than a predefined threshold limit upon evaluation of the finance historical information. the finance sanction module 130 also converts the predefined loan amount upon sanctioning into a virtual credit amount for utilization in purchasing of the one or more products selected by the purchaser. For example, the virtual credit amount is represented in form of a virtual credit card, wherein the virtual credit card is having a set of unique card number.

Upon conversion of the predefined loan amount into the virtual credit amount successfully, a transaction completion module 140 determines one or more merchants involved with selling of one or more corresponding products selected by the purchaser for checking out. For example, the one or more merchants includes one or more sellers having collaboration with the e-commerce platform for selling the one or more products. The transaction completion module 140 is also configured to identify a fraction of the virtual credit amount to be transferred to the corresponding one or more merchants determined based on extraction of a seller information associated with the at least one product from the electronic commerce platform. In the example used herein, the seller information includes, but not limited to, a name of the one or more merchants, a contact details of the one or more merchants, an address of the one or more merchants, a website link of the one or more merchants, number of quantities of the one or more products sold by the corresponding one or more merchants, a category of the one or more products sold by the corresponding one or more merchants and the like. The transaction completion module 140 is also configured to transmit the fraction of the virtual credit amount to the corresponding one or more merchants for completing transaction of purchasing the one or more products.

Further in case if the purchaser faces any financial crisis, then in such a scenario, an instalment conversion module 160 converts the virtual credit amount into a plurality of instalments for purchasing the one or more products based on a predefined requirement of the purchaser. In the example used herein, the plurality of instalments includes a plurality of equated monthly instalments (EMIs). The conversion of the virtual credit amount into the plurality of instalments helps in generation of sales for one or more expensive products which indirectly satisfies the purchaser, the one or more merchants and the one or more finance providers. As a result, the system enables the purchaser to finance the transaction even if the one or more merchants does not offer financing. As the transaction completion module uses virtual credit card, the one or more merchants does not need to make any change to their ecommerce platform to complete the transaction.

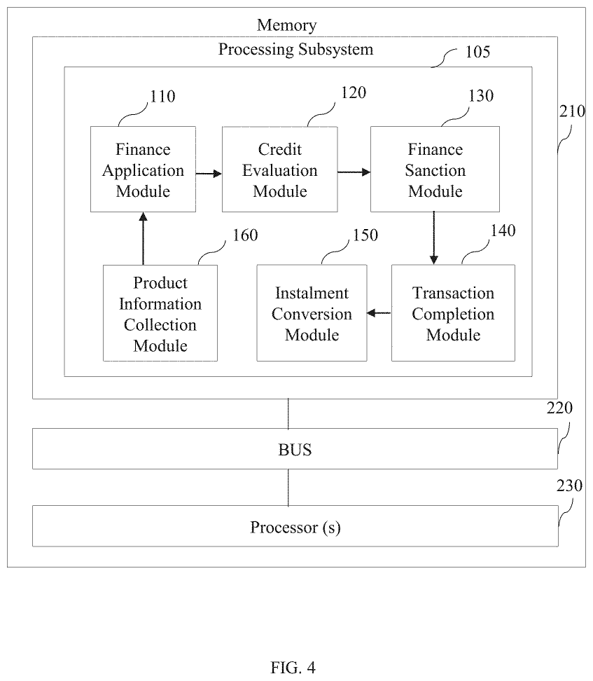

FIG. 4 is a block diagram of a computer or a server in accordance with an embodiment of the present disclosure. The server 200 includes processor(s) 230, and memory 210 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 is includes a processing subsystem 105 of FIG. 1. The processing subsystem 105 further has following modules: a finance application module 110, a credit evaluation module 120, a finance sanction module 130, a transaction completion module 140, a product information collection module 150 and an instalment conversion module 160.

The processing subsystem includes a finance application module 110 configured to receive a funding request to finance a loan for purchasing at least one product over an electronic commerce platform selected by a purchaser. The finance application module 110 is also configured to transmit the funding request received from the purchaser over a communication network to a finance service provider. The credit evaluation module 120 is configured to derive finance historical information of the purchaser from one or more external sources based on the funding request received corresponding to purchasing of the one or more products. The credit evaluation module 120 is also configured to evaluate the finance historical information derived of the purchaser for purchasing the one or more products selected based on analysis of a credit report associated with the purchaser. The finance sanction module 130 is configured to sanction financing of a predefined loan amount upon evaluation of the finance historical information. The finance sanction module 130 is also configured to convert the predefined loan amount upon sanctioning into a virtual credit amount for utilization in purchasing of the at least one product selected by the purchaser. The transaction completion module 140 is configured to determine one or more merchants involved with selling of the one or more corresponding products selected by the purchaser for checkout upon conversion of the predefined loan amount into the virtual credit amount. The transaction completion module 140 is also configured to identify a fraction of the virtual credit amount to be transferred to the corresponding one or more merchants determined based on extraction of a seller information associated with the one or more products from the electronic commerce platform. The transaction completion module 140 is also configured to transmit the fraction of the virtual credit amount to the corresponding one or more merchants for completing transaction of purchasing the one or more products. The product information collection module 150 is configured to collect one or more product details of the one or more products selected by the purchaser for purchasing from the electronic commerce platform. The instalment conversion module 160 is configured to convert the virtual credit amount into a plurality of instalments for purchasing the one or more products based on a predefined requirement of the purchaser.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus and the like.

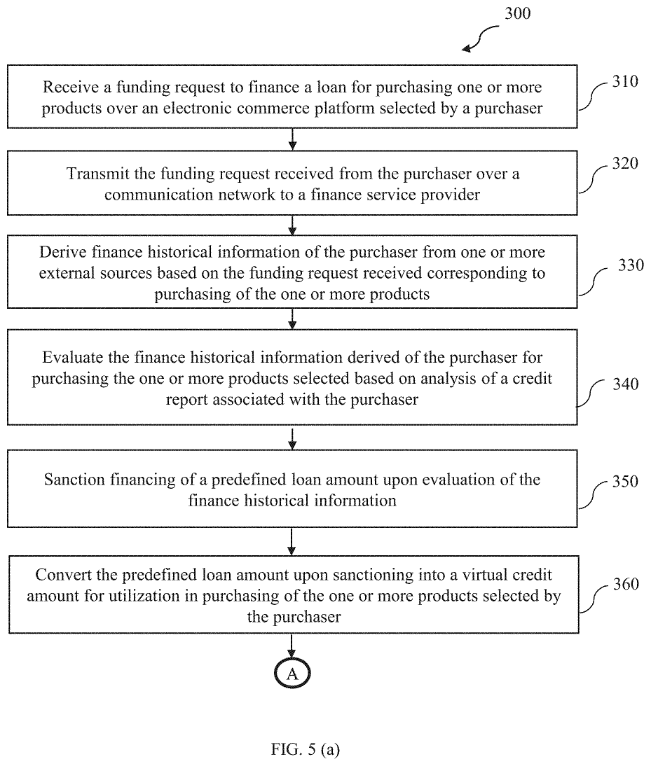

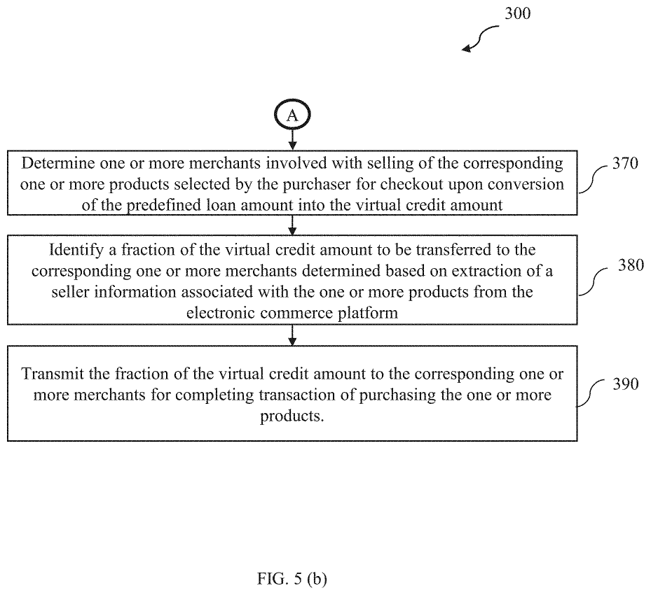

FIG. 5(a) illustrates a flowchart representing the steps involved in a method for financing an electronic purchase of a product of FIG. 1 in accordance with an embodiment of the present disclosure. The method 300 includes receiving, by a finance application module, a funding request to finance a loan for purchasing one or more products over an electronic commerce platform selected by a purchaser in step 310. In one embodiment, receiving the funding request includes at least one of a name of the purchaser, an address proof of the purchaser, a contact detail of the purchaser, an identification details of the purchaser, an income proof details of the purchaser, a type of loan requested by the purchaser, a loan amount requested by the purchaser, a time period of loan or a combination thereof. In such embodiment, the type of the loan includes, but not limited to, a personal loan, a vehicle loan, a gold loan, a home furnishing loan and the like.

The method 300 also includes transmitting, by the finance application module, the funding request received from the purchaser over a communication network to a finance service provider in step 320. The method 300 also includes deriving, by a credit evaluation module, finance historical information of the purchaser from one or more external sources based on the funding request received corresponding to purchasing of the one or more products in step 330. In one embodiment deriving the finance historical information of the purchaser from the one or more external sources may include deriving at least one of one or more payment history of the purchaser, a purchase history of the purchaser, a transaction history of the purchaser, a cash flow history of the purchaser, a balance history of the purchaser, a funding source of the purchaser or a combination thereof. In such embodiment, the one or more external sources may include at least one of an external electronic commerce website, a bank, a finance provider, a lender or a combination thereof.

The method 300 also includes evaluating, by the credit evaluation module, the finance historical information derived of the purchaser for purchasing the one or more products selected based on analysis of a credit report associated with the purchaser in step 340. In one embodiment, evaluating the finance historical information derived of the purchaser includes deriving a unique credit score from the credit report associated with the purchaser. In such embodiment, the credit report is analyzed for evaluation of the finance historical information by a credit analysis processing engine. In one embodiment, the credit analysis processing engine fetches a unique credit score associated with the purchaser from an external credit bureau platform using an application programming interface (API).

The method 300 also includes sanctioning, by a finance sanction module, financing of a predefined loan amount upon evaluation of the finance historical information in step 350. The method 300 also includes converting, by the finance sanction module, the predefined loan amount upon sanctioning into a virtual credit amount for utilization in purchasing of the one or more products selected by the purchaser in step 360. In one embodiment, converting the predefined loan amount into the virtual credit amount includes converting the predefined loan amount into the virtual credit amount associated with a virtual credit card generated for the purchaser, wherein the virtual credit card is having a set of unique number. In a specific embodiment, the method also includes approving, by the finance sanction module, sanction of financing the predefined loan amount when an evaluation score is greater than a predefined threshold limit upon evaluation of the finance historical information. In another embodiment, the method also includes declining, by the finance sanction module, the sanction of financing the predefined loan amount when an evaluation score is lesser than a predefined threshold limit upon evaluation of the finance historical information.

FIG. 5(b) illustrates continued steps of the method of FIG. 5(a) in accordance with an embodiment of the present disclosure. The method 300 also includes determining, by a transaction completion module, one or more merchants involved with selling of the one or more corresponding products selected by the purchaser for checkout upon conversion of the predefined loan amount into the virtual credit amount in step 370. In one embodiment, determining the one or more merchants involved with the selling of the at least one product selected by the purchaser includes determining one or more sellers having collaboration with the e-commerce platform for selling the one or more products.

The method 300 also includes identifying, by the transaction completion module, a fraction of the virtual credit amount to be transferred to the corresponding one or more merchants determined based on extraction of a seller information associated with the one or more products from the electronic commerce platform in step 380. In some embodiment, the seller information includes, but not limited to, a name of the corresponding one or more merchants, a contact details of the corresponding one or more merchants, an address of the corresponding one or more merchants, a website link of the corresponding one or more merchants, number of quantities of the one or more products sold by the one or more merchants, a category of the one or more products sold by the corresponding one or more merchants and the like. The method 300 also includes transmitting, by the transaction completion module, the fraction of the virtual credit amount to the corresponding one or more merchants for completing transaction of purchasing the one or more products in step 390.

Various embodiments of the present disclosure relate to an online financing system for facilitating the electronic purchase of the one or more products by increasing number of sales of the one or more merchants as well as encourages the purchaser for shopping.

Moreover, the present disclosed system automatically evaluates the credit information of the purchaser before granting of the loan option which not only reduces manual intervention of self-research by the purchaser but also reduces one or more anomalies generated during self-research by the purchaser related to the loan application process.

Furthermore, the present disclosed system also provides an instalment option to the purchaser for purchasing the one or more products from a single integrated platform which helps in overcoming one or more financial issues of the purchaser related to huge monetary deposits in times of emergency.

In addition, the present disclosed system also provides the predefined loan amount in form of virtual credit amount which is advantageous in terms of financial theft or one or more risks. Also, the virtual credit amount provides an easy access and time-saving option to the purchaser for any kind of online transactions.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for financing an electronic purchase of at least one product comprising:
a processing subsystem hosted on a server and configured to execute on a network to control bidirectional communications among a plurality of modules comprising:
a finance application module configured to:
receive a funding request to finance a loan for purchasing one or more products over an electronic commerce platform selected by a purchaser; and
transmit the funding request received from the purchaser over a communication network to a finance service provider;
a credit evaluation module operatively coupled to the finance application module, wherein the credit evaluation module is configured to:
derive finance historical information of the purchaser from one or more external sources based on the funding request received corresponding to purchasing of the one or more products; and
evaluate the finance historical information derived of the purchaser for purchasing the one or more products selected based on analysis of a credit report associated with the purchaser;
a finance sanction module operatively coupled to the credit evaluation module, wherein the finance sanction module is configured to:
sanction financing of a predefined loan amount upon evaluation of the finance historical information; and
convert the predefined loan amount upon sanctioning into a virtual credit amount for utilization in purchasing of the one or more products selected by the purchaser; and
a transaction completion module operatively coupled to the finance sanction module, wherein the transaction completion module is configured to:
determine one or more merchants involved with selling of the one or more corresponding products selected by the purchaser for checkout upon conversion of the predefined loan amount into the virtual credit amount;
identify a fraction of the virtual credit amount to be transferred to the corresponding one or more merchants determined based on extraction of a seller information associated with the one or more products from the electronic commerce platform; and
transmit the fraction of the virtual credit amount to the corresponding one or more merchants for completing transaction of purchasing the one or more products.

2. The system of claim 1, wherein the funding request comprises at least one of a name of the purchaser, an address proof of the purchaser, a contact detail of the purchaser, an identification details of the purchaser, an income proof details of the purchaser, a type of loan requested by the purchaser, a loan amount requested by the purchaser, a time period of loan or a combination thereof.

3. The system of claim 1, wherein the finance historical information comprises at least one of one or more payment history of the purchaser, a purchase history of the purchaser, a transaction history of the purchaser, a cash flow history of the purchaser, a balance history of the purchaser, a funding source of the purchaser or a combination thereof.

4. The system of claim 1, wherein the one or more external sources comprises at least one of an external electronic commerce website, a bank, a finance provider, a lender or a combination thereof.

5. The system of claim 1, wherein the credit report comprises a unique credit score associated with the purchaser.

6. The system of claim 1, wherein the credit report is analyzed for evaluation of the finance historical information by a credit analysis processing engine.

7. The system of claim 5, wherein the credit analysis processing engine is configured to fetch a unique credit score associated with the purchaser from an external credit bureau platform using an application programming interface.

8. The system of claim 1, wherein the finance sanction module is configured to approve sanction of financing the predefined loan amount when an evaluation score is greater than a predefined threshold limit upon evaluation of the finance historical information.

9. The system of claim 1, wherein the finance sanction module is configured to decline the sanction of financing the predefined loan amount when an evaluation score is lesser than a predefined threshold limit upon evaluation of the finance historical information.

10. The system of claim 1, wherein the virtual credit amount is associated with a virtual credit card generated for the purchaser, wherein the virtual credit card having a set of unique number.

11. The system of claim 1, wherein the processing subsystem comprises a product information collection module configured to collect one or more product details of the one or more products selected by the purchaser for purchasing from the electronic commerce platform.

12. The system of claim 11, wherein the one or more product details comprises at least one of a name of the one or more products, a quantity of the one or more products, a price of the one or more products, a brand of the one or more products or a combination thereof.

13. The system of claim 1, wherein the processing subsystem comprises an instalment conversion module operatively coupled to the finance sanction module, wherein the instalment conversion module is configured to convert the virtual credit amount into a plurality of instalments for purchasing the one or more products based on a predefined requirement of the purchaser.

14. A method comprising:
receiving, by a finance application module, a funding request to finance a loan for purchasing one or more products over an electronic commerce platform selected by a purchaser;
transmitting, by the finance application module, the funding request received from the purchaser over a communication network to a finance service provider;
deriving, by a credit evaluation module, finance historical information of the purchaser from one or more external sources based on the funding request received corresponding to purchasing of the one or more products;
evaluating, by the credit evaluation module, the finance historical information derived of the purchaser for purchasing the one or more products selected based on analysis of a credit report associated with the purchaser;
sanctioning, by a finance sanction module, financing of a predefined loan amount upon evaluation of the finance historical information;
converting, by the finance sanction module, the predefined loan amount upon sanctioning into a virtual credit amount for utilization in purchasing of the one or more products selected by the purchaser;
determining, by a transaction completion module, one or more merchants involved with selling of the corresponding one or more products selected by the purchaser for checkout upon conversion of the predefined loan amount into the virtual credit amount;
identifying, by the transaction completion module, a fraction of the virtual credit amount to be transferred to the corresponding one or more merchants determined based on extraction of a seller information associated with the one or more products from the electronic commerce platform; and
transmitting, by the transaction completion module, the fraction of the virtual credit amount to the corresponding one or more merchants for completing transaction of purchasing the one or more products.

15. The method of claim 14, comprising collecting, by a product information collection module, one or more product details of the one or more products selected by the purchaser for purchasing from the electronic commerce platform.

16. The method of claim 14, comprising converting, by an instalment conversion module, the virtual credit amount into a plurality of instalments for purchasing the one or more products based on a predefined requirement of the purchaser.
